(19) United States
(12) Patent Application Publication
(10) Pub. No.: US 2025/0208617 A1
(43) Pub. Date: Jun. 26, 2025

(54) IDENTIFICATION SYSTEM, IDENTIFICATION METHOD, AND IDENTIFICATION DEVICE

(71) Applicant: TOYOTA JIDOSHA KABUSHIKI KAISHA, Toyota-shi (JP)

(72) Inventor: Kento IWAHORI, Nagoya-shi (JP)

(73) Assignee: TOYOTA JIDOSHA KABUSHIKI KAISHA, Toyota-shi (JP)

(21) Appl. No.: 18/945,785

(22) Filed: Nov. 13, 2024

(30) Foreign Application Priority Data
Dec. 22, 2023 (JP) 2023-216865

(51) Int. Cl. G05D 1/221; G01S 13/12; G05D 109/10; G05D 111/30

(52) U.S. Cl. CPC G05D 1/221; G01S 13/12; G05D 2109/10; G05D 2111/30

(57) ABSTRACT

An identification system comprising: a target detection unit detecting a plurality of objects; a radio wave irradiation part sequentially irradiating a radio wave to the plurality of the objects detected by the target detection unit; a radio wave detection unit provided in each of the plurality of objects, the radio wave detection unit detecting the radio wave irradiated by the radio wave irradiation part; and an identification unit identifying at least one of the objects among the plurality of the objects using time series data of the radio wave detected by the radio wave detection unit.

### CROSS REFERENCE TO RELATED APPLICATIONS

This application claims priority from Japanese Patent Application No. 2023-216865, filed on Dec. 22, 2023, the disclosure of which is incorporated herein by reference in its entirety.

### BACKGROUND

### Field

This disclosure relates to an identification system, an identification method, and identification device.

### Related Art

U.S. patent Ser. No. 10/532,771 discloses a method of identifying a vehicle by sending a request to execute the operation of a device provided in the vehicle, such as the lighting of a headlight, to the vehicle via a radio communication network provided in the parking lot to confirm whether the vehicle has performed the operation.

In the prior art, the vehicle must perform some action to be identified. Therefore, the process for identifying the vehicle becomes complicated. In addition, the vehicle cannot be identified when the device for executing the vehicle operation is not installed in the vehicle. Such an issue is not limited to the vehicle but is common to other objects such as any moving object.

### SUMMARY

The present disclosure is feasible in the following aspects.
(1) According to a first aspect of the present disclosure, an identification system is provided. The identification system comprises: a target detection unit detecting a plurality of objects; a radio wave irradiation unit sequentially irradiating a radio wave to the plurality of the objects detected by the target detection unit; a radio wave detection unit provided in each of the plurality of objects, the radio wave detection unit detecting the radio wave irradiated by the radio wave irradiation unit; and an identification unit identifying at least one object among the plurality of the objects using time series data of the radio wave detected by the radio wave detection unit.

According to this aspect, the identification system can sequentially irradiate radio waves to the plurality of objects detected by the target detection unit. Then, the identification system can identify at least one object among the plurality of the objects using the time series data of the radio waves detected by the radio wave detection unit provided in each of the plurality of the objects. In this way, it is possible to identify the object without causing the object to perform some operation. Thus, the identification system can identify the object even when a device for executing an operation is not mounted on the object.
(2) In the above-described aspect, the time series data may be data in which reception timing of the radio wave in each of the plurality of objects is arranged in chronological order, the reception timing specified by an intensity change of the radio wave, the identification unit may identify the at least one object by collating the time series data with order in which the radio wave is irradiated to each of the plurality of the objects. According to this aspect, the identification system can identify the object by collating the order in which the radio wave is irradiated to each of the plurality of the objects and the time series data in which the reception timing of the radio wave in each of the plurality of objects is arranged in chronological order.
(3) In the above-described embodiment, the at least one objects may be a moving object movable by unmanned driving, the identification system may further comprise a control unit controlling operation of the at least one object, the identification unit may identify the at least one object to be controlled by the control unit among the plurality of the objects detected by the target detection unit. According to this aspect, the identification system can identify the object to be controlled.
(4) According to a second aspect of the present disclosure, an identification method is provided. The identification method comprises: an object detecting step of detecting a plurality of objects; a radio wave irradiating step of sequentially irradiating a radio wave to the plurality of the objects detected in the object detecting step; a radio wave detecting step of detecting the radio wave irradiated to each of the plurality of the objects in the radio wave irradiating step; and an identifying step of identifying at least one object among the plurality of objects using time series data of the radio wave detected in the radio wave detecting step. According to this aspect, it is possible to sequentially irradiate radio waves to the plurality of the objects detected in the object detecting step. Then, it is possible to identify at least one object among the plurality of the objects using the time series data of the radio waves detected in the radio wave detecting step. In this way, it is possible to identify the object without causing the object to perform some operation. Thus, it is possible to identify the object even when a device for executing an operation is not mounted on the object.
(5) According to a third aspect of the present disclosure, an identification device is provided. The identification device comprises: an identification unit identifying, using time series data of a radio wave detected by a radio wave detection unit provided in each of a plurality of objects, at least one object among the plurality of objects, wherein the radio wave is sequentially irradiated by a radio wave irradiation unit to the plurality of the objects detected by a target detection unit. According to this aspect, the identification device can identify at least one object among the plurality of the objects using the time series data of the radio waves sequentially irradiated to the plurality of the objects. In this way, it is possible to identify the object without causing the object to perform some operation. Thus, even when the device for executing the operation is not mounted on the object, it is possible to identify the object.

The present disclosure is feasible in various aspects other than the above-described the identification system, the identification methods, and the identification device. For example, the present disclosure is feasible in aspects such as a locating device locating a position of the object using an identification result by a identification device, a method of manufacturing an identification system, a method of manufacturing an identification device, a method of manufacturing a locating device, a method of controlling an identification system, a method of controlling an identification device, a control method of controlling a locating device, a computer program for realizing such a control method, and a non-transitory recording medium storing such a computer program.

### BRIEF DESCRIPTION OF THE DRAWINGS

FIG. 1 is a conceptual diagram showing the configuration of the driving system in the first embodiment;

FIG. 2 is a diagram for explaining the radiation mode of the radio wave;

FIG. 3 is a block diagram showing a configuration of the driving system in the first embodiment;

FIG. 4 is a schematic diagram showing the radio wave detection unit detected by the vehicle shown in FIG. 2;

FIG. 5 is a flow chart showing the process of the travel control of the vehicle according to the first embodiment;

FIG. 6 is a flow chart showing how to identify the target vehicle;

FIG. 7 is a block diagram showing a configuration of the driving system in the second embodiment;

FIG. 8 is a flow chart showing the process of the travel control of the vehicle in the second embodiment.

### DETAILED DESCRIPTION

### A. First Embodiment

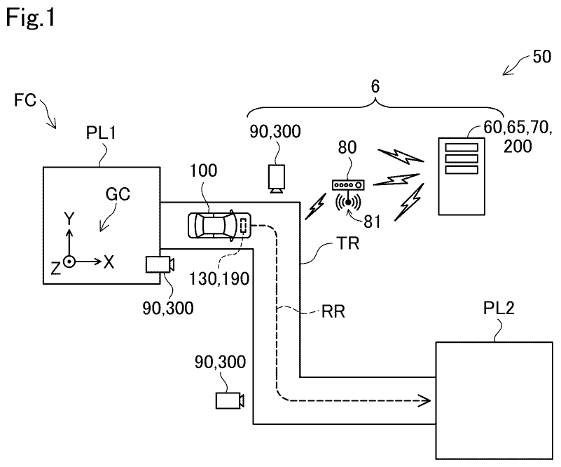

FIG. 1 is a conceptual diagram showing the configuration of a driving system 50 in the first embodiment. The driving system 50 is designed to move a moving object without running operation of a passenger on board the moving object. The driving system 50 comprises one or more vehicle 100 as the moving object, an identification system 6, a locating device 65 and a remote controller 70. The identification system 6 identifies at least one object among the plurality of objects. In the present embodiment, the object is the vehicle 100. The identification system 6 comprises the identification device 60, an access point 80 of 1 or greater, and a target detection unit 90 of 1 or greater. The identification device 60 identifies the vehicle 100. The locating device 65 locates the vehicle 100 using an identification result by the identification device 60. The remote controller 70 remotely controls the operation of the vehicle 100 using the position or the like of the vehicle 100. In the present embodiment, functions of the identification device 60, the locating device 65, and the remote controller 70 are realized by the server 200.

The target detection unit 90 detects a plurality of the vehicles 100. In the present embodiment, the target detection unit 90 is an external sensor 300. The external sensor 300 is a sensor located outside the vehicle 100. The external sensor 300 in this embodiment is a sensor capturing the vehicle 100 from the outside the vehicle 100. The external sensor 300 includes a communication device (not shown) and can communicate with other devices, such as the server 200, via wired or wireless communications. Specifically, the external sensor 300 is configured to be a camera. The camera as the external sensor 300 captures the vehicle 100 and outputs a captured image as detection result.

The access point 80 communicatively connects the vehicle 100 and the server 200 via a network. The access point 80 comprises a radio wave irradiation unit 81 for irradiating radio waves to a plurality of the vehicles 100 detected by the target detection unit 90. In the present embodiment, the radio wave irradiation unit 81 irradiates a plurality of the vehicles 100 detected by the external sensor 300 with radio waves in order.

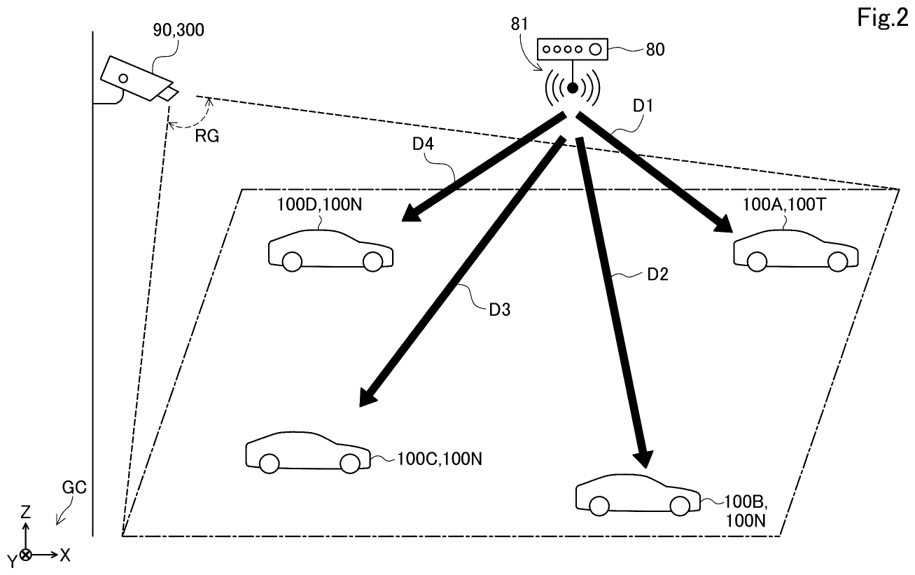

FIG. 2 is a diagram for explaining the irradiation mode of the radio wave. FIG. 2 illustrates the presence of four vehicles 100A-100D within the detection range RG of the external sensor 300. The radio wave irradiation unit 81 sequentially irradiates radio waves in directions D1-D4 in which the vehicle 100 exists. The radio wave irradiation unit 81 irradiates desired directions D1-D4 with radio waves, for example, using beamforming techniques. In this case, the radio wave irradiation unit 81 has a plurality of antennas. The radio wave irradiation unit 81, by changing the phase and the transmitted power for each antenna to control the directivity of the radio wave, to irradiate the radio waves in the desired directions D1-D4. In FIG. 2, the radio wave irradiation unit 81 irradiates radio waves in the order of the first direction D1, the second direction D2, the third direction D3, and the fourth direction D4. The first direction D1 is oriented from the access point 80 to the first vehicle 100A. The second direction D2 is oriented from the access point 80 to the second vehicle 100B. The third direction D3 is oriented from the access point 80 to the third vehicle 100C. The fourth direction D4 is oriented from the access point 80 to the fourth vehicle 100D.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a track, a bus, a two-wheel vehicle, a four-wheel vehicle, a combat vehicle, or a construction vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

As shown in FIG. 1, in the present embodiment, the driving system 50 is used in a factory FC of manufacturing the vehicle 100. the reference coordinate system of the factory is a global coordinate system and a location in the factory can be expressed by X, Y, and Z coordinates in the global coordinate system. The factory FC has a first location PL1 and a second location PL2. The first location PL1 and the second location PL2 are connected by a track TR on which the vehicle 100 can run. In the factory FC, a plurality of the external sensors 300 are installed along the track TR. The position of the external sensor 300 in the factory FC is pre-adjusted. The vehicle 100 moves from the first location PL1 to the second location PL2 through the track TR by the unmanned driving.

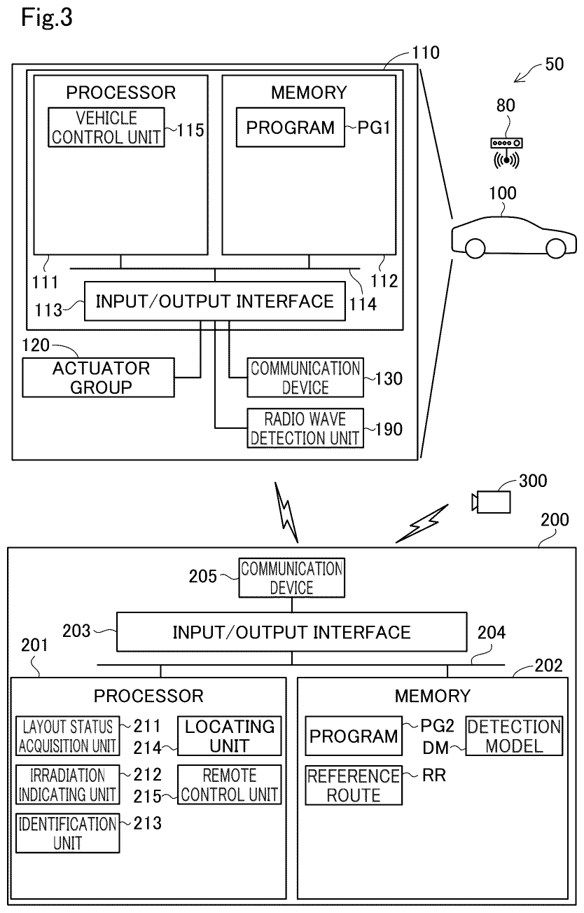

FIG. 3 is a block diagram showing a configuration of the driving system 50 in the first embodiment. The vehicle 100 includes a vehicle controller 110 controlling the various parts of the vehicle 100, an actuator group 120 including one or more actuators driven under the control of the vehicle controller 110, and a communication device 130 for wireless communication with external devices such as servers 200.

The vehicle controller 110 is configured by a computer including a processor 111, a memory 112, an input/output interface 113, and an internal bus 114. The processor 111, the memory 112, and the input/output interface 113 are connected to be able to communicate bidirectionally via the internal bus 114. The actuator group 120 and the communication device 130 are connected to the input/output interface 113. The processor 111 implements various functions including functions as the vehicle control unit 115 by executing a program PG1 stored in the memory 112.

The vehicle control unit 115 drives the vehicle 100 by controlling the actuator group 120. The vehicle control unit 115 can drive the vehicle 100 by controlling the actuator group 120 using the running control signal received from the server 200. The running control signal is a control signal for running the vehicle 100. In the present embodiment, the running control signal includes an acceleration and a steering angle of the vehicle 100 as parameters. In other embodiments, the running control signal may include the speed of the vehicle 100 as a parameter instead of or in addition to the acceleration of the vehicle 100.

The vehicle 100 further comprises a radio wave detection unit 190. The radio wave detection unit 190 detects radio waves irradiated by the radio wave irradiation unit 81. Then, the radio wave detection unit 190 associates a reception timing of the radio wave identified by the change in the strength of the radio wave with the vehicle identification information representing own vehicle 100 and transmits the reception timing associated with the vehicle identification information to the server 200. The vehicle identification information is a unique identifier allocated so that there is no overlap among the vehicles 100 to identify a plurality of the vehicles 100. The vehicle identification information is, for example, the vehicle identification number (VIN).

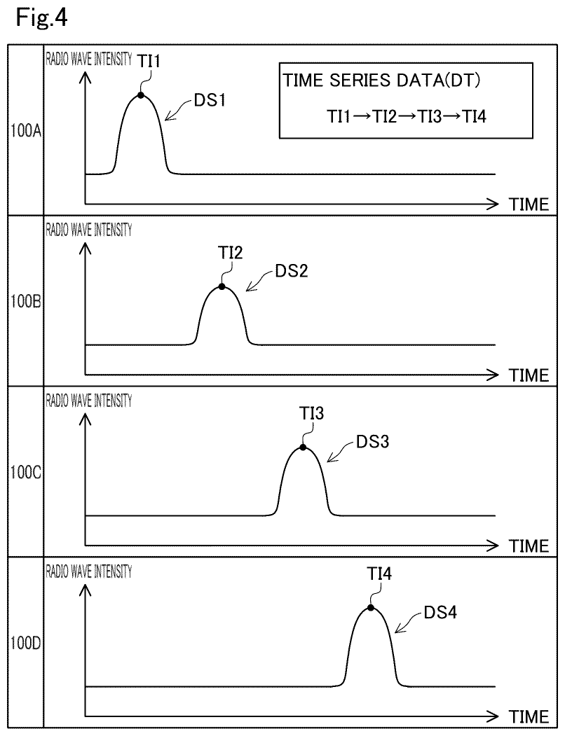

FIG. 4 is a schematic diagram showing the detected results of the radio wave detection unit 190 provided in the respective the vehicles 100A-100D shown in FIG. 2. FIG. 4 exemplifies a detection result in the case where the radio waves are irradiated in the order of the first direction D1, the second direction D2, the third direction D3, and the fourth direction D4 as shown in FIG. 2. The reception timing TI1-TI4 of a radio wave indicates, for example, the timing when the intensity of the radio wave shows the maximum value in the intensity transition data DS1-DS4 representing the transition of the intensity of the radio wave. The reception timing TI1-TI4 of the radio wave may be timing at which the strength of the radio wave has changed from a predetermined initial-value by a certain amount or more.

As shown in FIG. 3, the server 200 is configured by a computer with a processor 201, a memory 202, an input/output interface 203, and an internal bus 204. The processor 201, the memory 202, and the input/output interface 203 are connected to be able to communicate bidirectionally via the internal bus 204. The input/output interface 203 is connected to a communication device 205 for communicating with various devices outside the server 200. The communication device 205 may communicate with the vehicle 100 via wireless communication and may communicate with the external sensor 300 via wired or wireless communication. The processor 201 implements various functions, including functions as a layout status acquisition unit 211, a irradiation indicating unit 212, an identification unit 213, a locating unit 214, and a remote control unit 215, by executing a program PG2 stored in the memory 202.

The layout status acquisition unit 211 acquires the number of the vehicle 100 present in the detection range RG of the external sensor 300 and the position of the vehicle 100 by using the detection result output from the external sensor 300.

The irradiation indicating unit 212 determines the directions D1-D4 of radiation by locating the position of each vehicle 100 relative to the access point 80 based on the position of each vehicle 100 acquired by the layout status acquisition unit 211. Then, the irradiation indicating unit 212 determines the order in which the radio waves are irradiated to the respective directions D1-D4. Then, the irradiation indicating unit 212 instructs the access point 80 on the direction D1-D4 where radio waves are irradiated and the order where radio waves are irradiated in each direction D1-D4.

The identification unit 213 identifies at least one vehicle 100 among the plurality of the vehicle 100 using time series data DT of radio waves detected by the radio wave detection unit 190 provided in the respective the vehicle 100. As shown in FIG. 4, in the present embodiment, the time series data DT is data in which the reception timing TI1-TI4 of the radio waves in each of the vehicles 100A-100D arranged in chronological order. For example, the identification unit 213 identifies vehicles 100A-100D by collating the order in which the vehicles 100A-100D are irradiated with radio waves and the time series data DT. Thus, the identification unit 213 identifies the target vehicle 100T to be controlled by the remote control unit 215 among the vehicles 100A-100D detected by the external sensor 300.

For example, in the arrangement shown in FIG. 2, when the radio waves are irradiated in the order of the first direction D1, the second direction D2, the third direction D3, and the fourth direction D4, the reception timing TI1-TI4 of the radio waves is expected to be as follows. In this case, the first vehicle 100A is irradiated with a radio wave the earliest of the vehicles 100A-100D within the detection range RG of the external sensor 300. Therefore, it is expected that the reception timing TI1 of the radio wave by the first vehicle 100A is the earliest among the vehicles 100A-100D within the detection range RG of the external sensor 300. The fourth vehicle 100D is irradiated with a radio wave the latest of the vehicles 100A-100D within the detection range RG of the external sensor 300. Therefore, it is expected that the reception timing TI4 of the radio wave by the fourth vehicle 100D is the latest of the vehicles 100A-100D within the detection range RG of the external sensor 300. The second vehicle 100B is irradiated with a radio wave later than the first vehicle 100A and earlier than the third vehicle 100C. Therefore, it is expected that the reception timing TI2 of the radio wave by the second vehicle is later than the first vehicle 100A and earlier than the third vehicle 100C. The third vehicle 100C is irradiated with a radio wave later than the second vehicle 100B and earlier than the fourth vehicle 100D. Therefore, it is expected that the third vehicle 100C radio wave the reception timing TI3 is later than the second vehicle 100B and earlier than the fourth vehicle 100D. From the above, it is expected that when radio waves are irradiated in the order of the first direction D1, the second direction D2, the third direction D3, and the fourth direction D4 in the arrangement conditions shown in FIG. 2, the time series data DT will be as follows. In this case, as shown in FIG. 4, the time series data DT is expected to indicate that the radio waves are received in the order of the first vehicle 100A, the second vehicle 100B, the third vehicle 100C, and the fourth vehicle 100D.

Therefore, the identification unit 213 links the order in which each of the plurality of the vehicles 100A-100D is irradiated with radio waves with the time series data DT, and associates the vehicle identification information with each the vehicles 100A-100D in the captured image. Thus, the identification unit 213 identifies the plurality of the vehicle 100A-100D. Then, the identification unit 213 specifies, among the plurality of vehicles detected by the external sensor 300, the vehicle 100 to which the vehicle identification information of a predetermined target vehicle 100T is associated as the target vehicle 100T. This allows the identification unit 213 to identify the target vehicle 100T from the non target vehicle 100N other than the target vehicle 100T.

The locating unit 214 identifies the location of each vehicle 100 by using the identification result of the vehicle 100 by the identification unit 213 to associate the vehicle identification information with the location of each vehicle 100 acquired by the layout status acquisition unit 211. This allows the locating unit 214 to locate the target vehicle 100T.

The remote control unit 215 drives the vehicle 100 by the remote control by generating the running control signal for controlling the actuator group 120 of the vehicle 100 using the detection result by the sensor and transmitting the running control signal to the vehicle 100.

At least some functions of the server 200 may be implemented by the vehicle controller 110 or the external sensor 300.

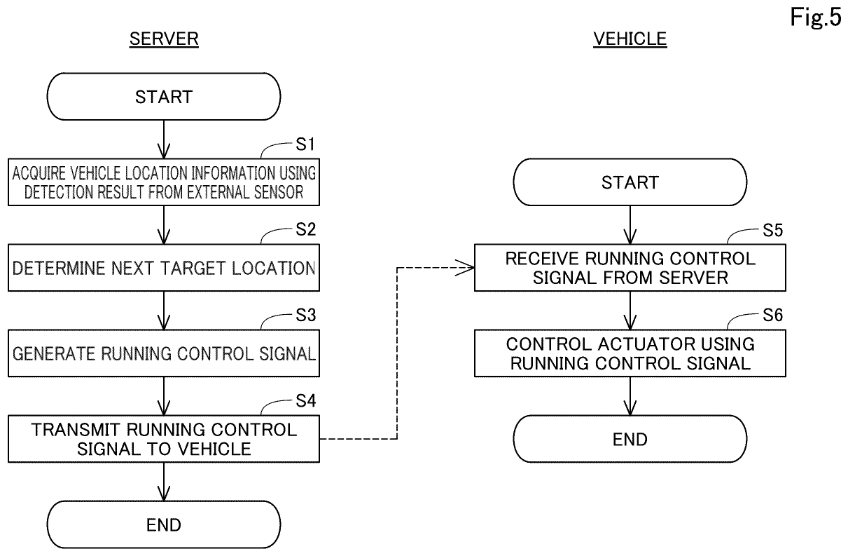

FIG. 5 is a flowchart showing a processing procedure for running control of the vehicle 100 in the first embodiment. The flowchart shown in FIG. 5 is performed, for example, after the target vehicle 100T has been identified. In the processing procedure shown in FIG. 5, the processor 201 of the server 200 functions as the layout status acquisition unit 211, the irradiation indicating unit 212, the identification unit 213, the locating unit 214, and the remote control unit 215 by executing the program PG2. In addition, the processor 111 of the vehicle 100 functions as the vehicle control unit 115 by executing the program PG1.

In step S1, the processor 201 of the server 200 acquires vehicle location information using the detection result output from the external sensor 300. The vehicle location information is locational information as a basis for generating a running control signal. In the present embodiment, the vehicle location information includes the location and orientation of the vehicle 100 in the global coordinate system GC of the factory FC. Specifically, in step S1, the processor 201 acquires the vehicle location information using the captured image acquired from the camera as the external sensor.

More specifically, in step S1, the processor 201 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system GC, thereby acquiring the location of the vehicle 100. The outer shape of the vehicle 100 in the captured image may be detected by inputting the captured image to a detection model DM using artificial intelligence, for example. The detection model DM is prepared in the driving system 50 or outside the driving system 50. The detection model DM is stored in advance in the memory 202 of the server 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model DM and the label. The processor 201 can acquire the orientation of the vehicle 100 through estimation based on the direction of a motion vector of the vehicle 100 detected from change in location of a feature point of the vehicle 100 between frames of the captured images using optical flow process, for example.

In step S2, the processor 201 of the server 200 determines a target location to which the vehicle 100 is to move next. In the present embodiment, the target location is expressed by X, Y, and Z coordinates in the global coordinate system. The memory 202 of the server 200 contains a reference route RR stored in advance as a route along which the vehicle 100 is to run. The route is expressed by a node indicating a departure place, a node indicating a way point, a node indicating a destination, and a link connecting nodes to each other. The processor 201 determines the target location to which the vehicle 100 is to move next using the vehicle location information and the reference route RR. The processor 201 determines the target location on the reference route RR ahead of a current location of the vehicle 100.

In step S3, the processor 201 of the server 200 generates a running control signal for causing the vehicle 100 to run toward the determined target location. The processor 201 calculates a running speed of the vehicle 100 from transition of the location of the vehicle 100 and makes comparison between the calculated running speed and a target speed of the vehicle 100 determined in advance. If the running speed is lower than the target speed, the processor 201 generally determines an acceleration in such a manner as to accelerate the vehicle 100. If the running speed is higher than the target speed as, the server 200 generally determines an acceleration in such a manner as to decelerate the vehicle 100. If the vehicle 100 is on the reference route RR, server 200 determines a steering angle and an acceleration in such a manner as to prevent the vehicle 100 from deviating from the reference route. RR If the vehicle 100 is not on the reference route RR, in other words, if the vehicle 100 deviates from the reference route RR, the processor 201 determines a steering angle and an acceleration in such a manner as to return the vehicle 100 to the reference route RR.

In step S4, the processor 201 of the server 200 transmits the generated running control signal to the vehicle 100. The processor 201 repeats the acquisition of vehicle location information, the determination of a target location, the generation of a running control signal, the transmission of the running control signal, and others in a predetermined cycle.

In step S5, the processor 111 of the vehicle 100 receives the running control signal transmitted from the server 200. In step S6, the processor 111 of the vehicle 100 controls the actuator group 120 of the vehicle 100 using the received running control signal, thereby causing the vehicle 100 to run at the acceleration and the steering angle indicated by the running control signal. The vehicle 100 repeats the reception of a running control signal and the control over the actuator group 120 in a predetermined cycle. According to the driving system 50 in the present embodiment, it becomes possible to move the vehicle 100 without using a transport unit such as a crane or a conveyor.

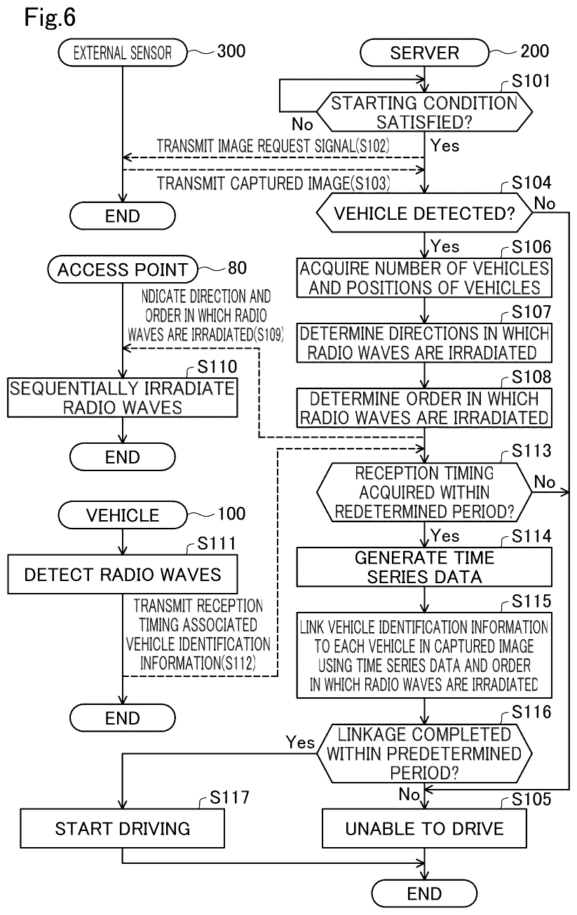

FIG. 6 is a flow chart showing how to identify the target vehicle 100T. When the remote control is used to drive the target vehicle 100T, and the detection range RG of the external sensor 300 includes a plurality of the vehicles 100, the target vehicle 100T must be identified from the non target vehicle 100N prior to starting the target vehicle 100T running. Therefore, the flowchart shown in FIG. 6 is executed, for example, prior to starting the target vehicle 100T running.

When the predetermined starting condition is satisfied (step S101: Yes), the layout status acquisition unit 211 of the server 200 executes step S102. In step S102, the layout status acquisition unit 211 transmits an image request signal for acquiring a captured image to the external sensor 300 that is scheduled to include the target vehicle 100T in its detection range RG. In step S103, the external sensor 300 that has been received the image request signal transmits the captured image to the server 200.

When the vehicle 100 is not detected from the captured image (step S104: No), the identification unit 213 of the server 200 makes a determination as shown in step S105. In Step S105, the identification unit 213 determines that the target vehicle 100T must not be started because the target vehicle 100T cannot be identified.

If the vehicle 100 is detected from the captured image (step S104: Yes), the layout status acquisition unit 211 of the server 200 performs step S106. In step S106, the layout status acquisition unit 211 acquires the number of the vehicle 100 present in the detection range RG of the external sensor 300 and the positions of the vehicle 100 using the captured image. In step S107, the irradiation indicating unit 212 determines the directions D1-D4 in which the radio waves are irradiated by locating the position of the vehicle 100 relative to the access point 80 based on the position of each vehicle 100 acquired by the layout status acquisition unit 211. In step S108, the irradiation indicating unit 212 determines the order in which the radio waves are irradiated in the directions D1-D4. In step S109, the irradiation indicating unit 212 instructs the access point 80 on the direction D1-D4 in which the radio waves are irradiated and the order in which the radio waves are irradiated to each direction D1-D4.

In step S110, the radio wave irradiation unit 81 of the access point 80 sequentially irradiates the radio waves in the directions D1-D4 in which the vehicles 100 exist, according to the instruction received from the irradiation indicating unit 212 of the server 200. In step S111, the radio wave detection unit 190 of the vehicle 100 detects the radio wave emitted by the radio wave irradiation unit 81. In step S112, the radio wave detection unit 190 associates the vehicle identification information representing the own vehicle 100 with the reception timing TI1-TI4 of the radio waves specified by the strength change of the radio waves and transmits the vehicle identification information associated the reception timing to the server 200.

If the reception timing TI1-TI4 of any vehicle 100 detected from the captured images cannot be acquired within a predetermined period (step S113: No), the identification unit 213 determines that the target vehicle 100T must not begin to run, as shown in step S105. When it is determined as “No” in step S113, the identification system 6 may re-execute the step S110 to S112 and try to acquire the reception timing TI1-TI4 of all vehicles 100 detected from the captured images again.

If the reception timing TI1-TI4 of all the vehicles 100 detected from the captured image is acquired within a predetermined period (step S113: Yes), the identification unit 213 of the server 200 performs step S114. In the stepped S114, the identification unit 213 generates the time series data DT by arranging the reception timing TI1-TI4 of the radio waves received from the vehicle 100 in chronological order. In step S115, the identification unit 213 links the vehicle identification information with each vehicle 100 in the captured image by collating the order in which the plurality of the vehicle 100 are irradiated with the radio waves with the time series data DT. Thus, the identification unit 213 identifies the target vehicle 100T.

If the linkage of the vehicle identification information to any vehicle 100 in the captured image is not completed within a predetermined period (step S116: No), the identification unit 213 determines that the target vehicle 100T must not be started to run, as shown in step S105. When it is determined as “No” in the step S116, the identification system 6 may re-execute the step S114 and the step S115 and try to identify the target vehicle 100T again.

When the linkage of the vehicle identification information to all the vehicles 100 in the captured images is completed within a predetermined period (step S116: Yes), the identification unit 213 determines as shown in step S117. In step S117, since the identification unit 213 can identify the target vehicle 100T, it is determined that running of the target vehicle 100T may be started.

According to the above-described first embodiment, the identification system 6 can identify the vehicle 100 by collating the order in which a plurality of the vehicle 100 are irradiated with radio waves with the time series data DT. In this way, the vehicle 100 can be identified without causing the vehicle 100 to perform any operation. This allows the vehicle 100 to be identified by the identification system 6 even when the device for executing the operation is not mounted on the vehicle 100.

According to the above-described first embodiment, the identification system 6 can identify the target vehicle 100T to be controlled. In this way, the vehicle location information of the target vehicle 100T can be obtained. In this way, it is possible to cause the target vehicle 100T to run with the remote control by generating the running control signal using the vehicle location information.

### B. Second Embodiment

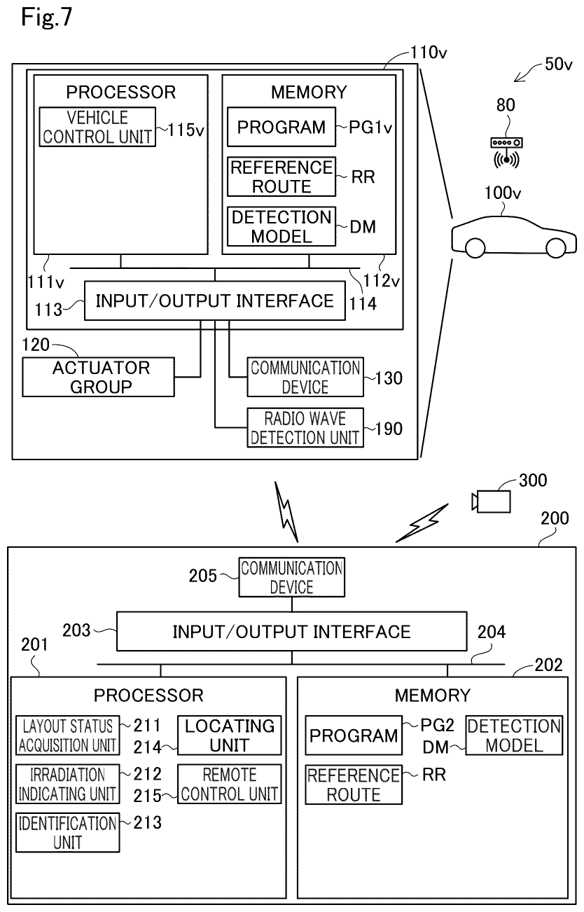

FIG. 7 is a block diagram showing a configuration of a driving system 50v in the second embodiment. A vehicle 100v according to the present embodiment can be further driven by the autonomous control of the vehicle 100v. For other configurations, unless otherwise described, it is the same as the first embodiment.

In this embodiment, the processor 111v of the vehicle controller 110v functions as a vehicle control unit 115v by executing the program PG1v stored in the memory 112v. The vehicle control unit 115v can allow the vehicle 100v to run under autonomous control by acquiring the output result by the sensor, generating the running control signal using the output result, and outputting the generated running control signal to operate the actuator group 120. In the present embodiment, in addition to the program PG1v, the detection model DM and the reference route RR are stored in the memory 112v in advance.

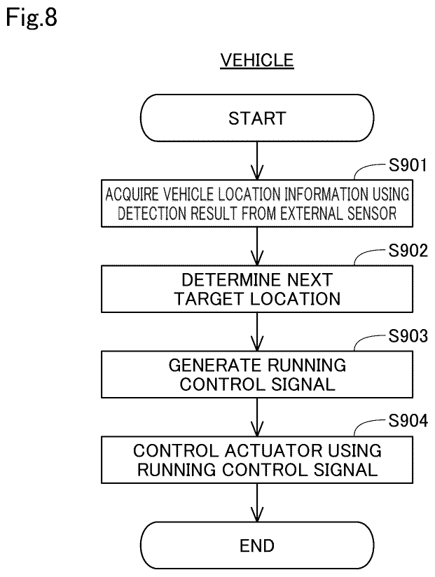

FIG. 8 is a flowchart showing a processing procedure for running control of the vehicle 100v in the second embodiment. In FIG. 8 process, the processor 111v of the vehicle 100v functions as the vehicle control unit 115v by executing the program PG1v.

In step S901, the processor 111v of the vehicle 100 acquires vehicle location information using detection result output from the camera as an external sensor 300. In step S902, the processor 111v determines a target location to which the vehicle 100v is to move next. In step S903, the processor 111v generates a running control signal for causing the vehicle 100v to run to the determined target location. In step S904, the vehicle 100v controls the actuator group 120 using the generated running control signal, thereby causing the vehicle 100v to run by following a parameter indicated by the running control signal. The processor 111v repeats the acquisition of vehicle location information, the determination of a target location, the generation of a running control signal, and the control over the actuator in a predetermined cycle. According to the running control in the driving system 50v in the present embodiment, it is possible to cause the vehicle 100v to run by autonomous control without controlling the vehicle 100v remotely using the server 200.

### C. Other Embodiments

### C-1. Other Embodiment 1

When radio waves are irradiated in a specific direction D1-D4 from the radio wave irradiation unit 81 of the access point 80 and a plurality of the vehicle 100, 100v exist along the specific direction D1-D4, the radio waves are irradiated in the following order. In this case, the radio wave are emitted earlier to the vehicle 100, 100v of which the distance to the access point 80 is smaller and emitted later to the vehicle 100, 100v of which the distance to the access point 80 is larger. Therefore, in this case, the identification unit 213 determines the order in which the radio wave is irradiated to each of the plurality of the vehicle 100,100v according to each distance of vehicle 100, 100v from the access point 80. Then, the identification unit 213 identifies the vehicle 100,100v using the determined order and the time series data DT. According to this aspect, the vehicle 100, 100v can be identified even when there are more than one vehicle 100, 100v in the direction D1-D4 in which the radio waves are irradiated.

### C-2. Other Embodiment 2

Radio waves may be irradiated in the direction D1-D4 in which the vehicles 100, 100v exist respectively from the radio wave irradiation unit 81 of a plurality of access points 80 arranged at different locations. In this case, the reception timing TI1-TI4 and reception strength of the radio waves differ according to the distance between the vehicle 100,100v and the access point 80 in addition to the order in which the radio waves are irradiated to the respective directional D1-D4. Therefore, the identification unit 213 identifies the vehicle 100, 100v by using, for example, the order in which each the radio wave irradiation unit 81 irradiates a radio wave to each of the plurality of the vehicle 100, 100v, the time series data DT, the distance between each the vehicle 100, 100v and each the access point 80, and the magnitude relationship of the reception strength of the radio wave. According to this aspect, the vehicle 100,100v can be identified using the detected radio waves emitted from the radio wave irradiation unit 81 of the plurality of the access points 80 arranged at different locations.

### C-3. Other Embodiment 3

In each of the above-described embodiments, the object to be identified is the vehicle 100, 100v that can be moved by the unmanned driving. In contrast, in other embodiments, the object may be an object other than the vehicle 100,100v. The object may be, for example, a moving object other than the vehicle 100, 100v.

### C-4. Other Embodiment 4

In each of the above-described embodiments, the external sensor is not limited to the camera but may be the distance measuring device, for example. The distance measuring device is a light detection and ranging (LiDAR) device, for example. In this case, detection result output from the external sensor may be three-dimensional point cloud data representing the vehicle 100,100v. The server 200 and the vehicle 100,100v may acquire the vehicle location information through template matching using the three-dimensional point cloud data as the detection result and reference point cloud data, for example.

### C-5. Other Embodiment 5

In the above-described first embodiment, the server 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.
(1) The server 200 may acquire vehicle location information, determine a target location to which the vehicle 100 is to move next, and generate a route from a current location of the vehicle 100 indicated by the acquired vehicle location information to the target location. The server 200 may generate a route to the target location between the current location and a destination or generate a route to the destination. The server 200 may transmit the generated route to the vehicle 100. The vehicle 100 may generate a running control signal in such a manner as to cause the vehicle 100 to run along the route received from the server 200 and control the actuator group 120 using the generated running control signal.
(2) The server 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the actuator group 120 using the generated running control signal.
(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. The internal sensor may include, for example, a sensor detecting a motion state of the vehicle 100, an operation state of each part of the vehicle 100, and a sensor detecting the ambient environment around the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

### C-6. Other Embodiment 6

In the above-described second embodiment, the vehicle 100v may be equipped with an internal sensor, and detection result output from the internal sensor may be used in at least one of generation of a route and generation of a running control signal. For example, the vehicle 100v may acquire detection result from the internal sensor, and in generating the route, may reflect the detection result from the internal sensor in the route. The vehicle 100v may acquire detection result from the internal sensor, and in generating the running control signal, may reflect the detection result from the internal sensor in the running control signal.

### C-7. Other Embodiments 7

In the above-described embodiment in which the vehicle 100v can be running by autonomous control, the vehicle 100v acquires vehicle location information using detection result from the external sensor 300. By contrast, the vehicle 100v may be equipped with an internal sensor, the vehicle 100v may acquire vehicle location information using detection result from the internal sensor, determine a target location to which the vehicle 100v is to move next, generate a route from a current location of the vehicle 100v indicated by the acquired vehicle location information to the target location, generate a running control signal for running along the generated route, and control the actuator group 120 of the vehicle 100v using the generated running control signal. In this case, the vehicle 100v is capable of running without using any detection result from an external sensor 300. The vehicle 100v may acquire target arrival time or traffic congestion information from outside the vehicle 100v and reflect the target arrival time or traffic congestion information in at least one of the route and the running control signal.

### C-8. Other Embodiment 8

In the above-described first embodiment, the server 200 automatically generates a running control signal to be transmitted to the vehicle 100. By contrast, the server 200 may generate a running control signal to be transmitted to the vehicle 100 in response to operation by an external operator existing outside the vehicle 100. For example, the external operator may operate an operating device including a display on which a captured image output from the external sensor 300 is displayed, steering, an accelerator pedal, and a brake pedal for operating the vehicle 100 remotely, and a communication device for making communication with the server 200 through wire communication or wireless communication, for example, and the server 200 may generate a running control signal responsive to the operation on the operating device.

### C-9. Other Embodiment 9

In each of the above-described embodiments, the vehicle 100, 100v is simply required to have a configuration to become movable by unmanned driving. The vehicle 100, 100v may embodied as a platform having the following configuration, for example. The vehicle 100,100v is simply required to include at least the vehicle controller 110 and the actuator group 120. In order for the vehicle 100,100v to acquire information from outside for unmanned driving, the vehicle 100,100v is simply required to include the communication device further. Specifically, the vehicle 100, 100v to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100, 100v before the vehicle 100,100v is shipped from a factory, or a remaining component such as a bodyshell may be mounted on the vehicle 100, 100v after the vehicle 100, 100v is shipped from a factory while the remaining component such as a bodyshell is not mounted on the vehicle 100,100v. Each of components may be mounted on the vehicle 100, 100v from any direction such as from above, from below, from the front, from the back, from the right, or from the left. Alternatively, these components may be mounted from the same direction or from respective different directions. The location determination for the platform may be performed in the same way as for the vehicle 100, 100v in the first embodiments.

### C-10. Other Embodiment 10

The vehicle 100, 100v may be manufactured by combining a plurality of modules. The module means a unit composed of one or more components grouped according to a configuration or function of the vehicle 100,100v. For example, a platform of the vehicle 100,100v may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100, 100v different from the platform may be modularized. Various modules may include an arbitrary exterior component such as a bumper or a grill, or an arbitrary interior component such as a seat or a console. Not only the vehicle 100,100v but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

### C-11. Other Embodiment 11

A configuration for realizing running of the vehicle 100,100v by unmanned driving is also called a “Remote Control auto Driving system”. Conveying the vehicle 100,100v using Remote Control Auto Driving system is also called “self-running conveyance”. Producing the vehicle 100,100v using self-running conveyance is also called “self-running production”. In self-running production, for example, at least part of the conveyance of vehicles 100,100v is realized by self-running conveyance in a factory where the vehicle 100, 100v is manufactured.

### C-12. Other Embodiments 12

In each of the above-described embodiments, some or all of functions and processes realized by software may be realized by hardware. Furthermore, some or all of functions and processes realized by hardware may be realized by software. For example, any type of circuit such as an integrated circuit or a discrete circuit may be used as hardware for realizing the functions described in each of the foregoing embodiments.

The present disclosure is not limited to the embodiments described above and is able to be implemented with various configurations without departing from the spirit thereof. For example, the technical features of any of the embodiment, the examples and the modifications corresponding to the technical features of each of the aspects described in SUMMARY may be replaced or combined appropriately, in order to solve part or all of the problems described above or in order to achieve part or all of the advantageous effects described above. When the technical features are not described as essential features in the present specification, they are able to be deleted as necessary.

What is claimed is:

1. An identification system comprising:
a target detection unit detecting a plurality of objects;
a radio wave irradiation unit sequentially irradiating a radio wave to the plurality of the objects detected by the target detection unit;
a radio wave detection unit provided in each of the plurality of objects, the radio wave detection unit detecting the radio wave irradiated by the radio wave irradiation unit; and
an identification unit identifying at least one object among the plurality of the objects using time series data of the radio wave detected by the radio wave detection unit.

2. The identification system of claim 1, wherein
the time series data is data in which reception timing of the radio wave in each of the plurality of objects is arranged in chronological order, the reception timing specified by an intensity change of the radio wave,
the identification unit identifies the at least one object by collating the time series data with order in which the radio wave is irradiated to each of the plurality of the objects.

3. The identification system of claim 1, wherein
the at least one objects is a moving object movable by unmanned driving,
the identification system further comprises a control unit controlling operation of the at least one object,
the identification unit identifies the at least one object to be controlled by the control unit among the plurality of the objects detected by the target detection unit.

4. An identification method comprising:
an object detecting step of detecting a plurality of objects;
a radio wave irradiating step of sequentially irradiating a radio wave to the plurality of the objects detected in the object detecting step;
a radio wave detecting step of detecting the radio wave irradiated to each of the plurality of the objects in the radio wave irradiating step; and
an identifying step of identifying at least one object among the plurality of objects using time series data of the radio wave detected in the radio wave detecting step.

5. An identification device comprising:
an identification unit identifying, using time series data of a radio wave detected by a radio wave detection unit provided in each of a plurality of objects, at least one object among the plurality of objects, wherein the radio wave is sequentially irradiated by a radio wave irradiation unit to the plurality of the objects detected by a target detection unit.
